(19) United States
(12) Patent Application Publication
(10) Pub. No.: US 2008/0020174 A1
(43) Pub. Date: Jan. 24, 2008

(54) SYNTHETIC TURF

(76) Inventors: Thomas E. STULL, Decatur, TN (US); James C. KLINGENSMITH, Rome, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/829,400

(22) Filed: Jul. 27, 2007

Related U.S. Application Data
(62) Division of application No. 11/157,004, filed on Jun. 20, 2005.
(60) Provisional application No. 60/589,114, filed on Jul. 19, 2004.

(51) Int. Cl. B32B 33/00

(52) U.S. Cl. 428/95

(57) ABSTRACT

A synthetic turf comprising a tufted material having a hot melt adhesive applied to a back side thereof at a rate of no more than about 12 oz/yd², wherein the turf has a tuft lock strength of at least 5 pounds in accordance with the tuft lock test of ASTM-D 1335 and a water permeability of at least about 40 inches/hour in accordance with test DIN 18-035.

### CROSS-REFERENCE TO RELATED APPLICATION

This application is a divisional application of and claims benefit of U.S. patent application Ser. No. 11/157,004, filed Jun. 20, 2005, entitled “Synthetic Turf and Method For Applying Adhesive,” which claims benefit to U.S. Provisional Application Ser. No. 60/589,114, filed Jul. 19, 2004, entitled “Synthetic Turf,” each of which is incorporated herein by reference as if set forth herein in its entirety.

### FIELD OF THE INVENTION

This invention relates generally to synthetic turf products and to methods for applying adhesive to tufted products including carpet and synthetic turf products. More particularly, this invention relates to tufted substrates such as synthetic turf products having improved characteristics and to methods for manufacture of such products by application of thermoplastic adhesive.

### BACKGROUND AND SUMMARY OF THE INVENTION

Synthetic turf is often used for athletic fields. Synthetic turf is also popular as a replacement for natural turf in arid climates. Conventional synthetic turf and other tufted products typically utilizes polyolefin polymer fibers, such as polyethylene or polypropylene, or nylon fibers tufted into a backing material made of polyolefin polypropylene. An adhesive, typically a thermosetting type adhesive such as polyurethane/rubber latex adhesive, is applied as substantially uniform film to the back side of the backing material and the resulting product is heated in an oven to cure the adhesive. Such conventional synthetic turf and other tufted products and the manufacture thereof desire improvement.

For example, the heat curing step to cure the thermosetting adhesive is costly and cumbersome. Also, the resulting product often contains wrinkles or shrinkage from the heat curing step, which detracts from the aesthetics and usability of the product. The product is also substantially non-permeable and must be needle punched or otherwise perforated to provide for water drainage when drainage is a desired characteristic.

The invention provides tufted products and methods for manufacturing the same. In a preferred embodiment, a method for manufacturing a synthetic turf includes the steps of providing a tufted material having a plurality of bundles of fibers extending outwardly from a front side thereof; providing a hot melt adhesive having a ring and ball softening point and heating the adhesive to a temperature corresponding to at least its ring and ball softening point; and applying the thus heated hot melt adhesive to a back side of the tufted material, wherein the adhesive cools to a temperature substantially below its ring and ball softening point after it has been applied to the back side of the tufted material.

The thus treated material is then preferably passed against and around a heated drum maintained at a temperature substantially corresponding to the ring and ball softening point of the hot melt adhesive to render the adhesive in a sufficiently plastic state such that the adhesive substantially penetrates into interstices of the bundles of fibers to substantially bind together each of the fibers of each of the bundles.

### BRIEF DESCRIPTION OF THE DRAWINGS

Further features of preferred embodiments of the invention will become apparent by reference to the detailed description of preferred embodiments when considered in conjunction with the figures, which are not to scale, wherein like reference numbers, indicate like elements through the several views, and wherein,

FIG. 1 is a cross-sectional side view of synthetic turf in accordance with a preferred embodiment of the invention.

FIG. 2 shows manufacture of synthetic turf in accordance with a preferred embodiment of the invention.

FIG. 3 shows a preferred manner of application of adhesive to the back side of the primary backing.

FIG. 4 is a representational plan view showing the back side of the primary backing after the adhesive has been set by passage around the drum to yield a fragmented or discontinuous deposition of adhesive.

### DETAILED DESCRIPTION

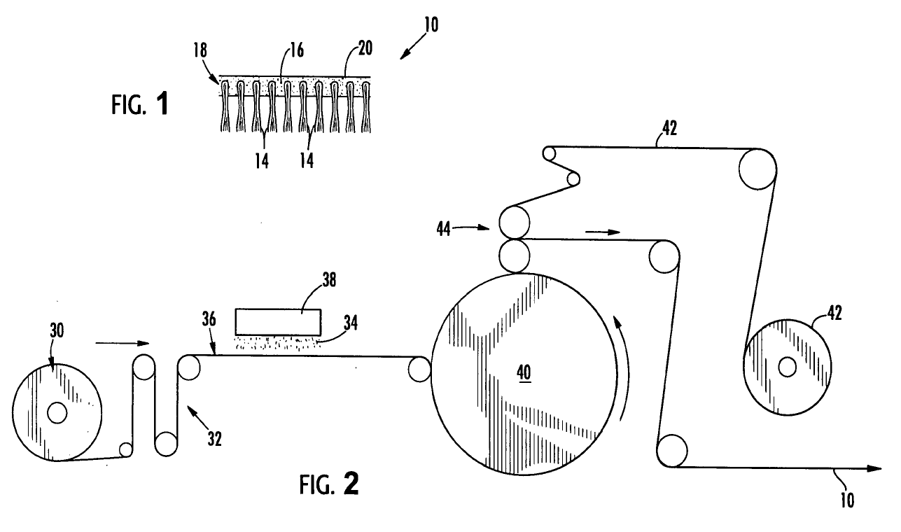

With reference to FIG. 1, there is shown a tufted product in the form of a synthetic turf 10 in accordance with a preferred embodiment of the invention. The turf 10 preferably includes a primary backing or backings 12 having a plurality of fibers 14 tufted thereto in the manner of tufted carpet. That is, a number of tufts are collected into bundles and punched through the backing 12.

In accordance with the invention, an adhesive 16 is applied to back side 18 of the primary backing 12. The adhesive 16 is provided in the manner described herein to lock the fibers 14 to the primary backing 12 and to glue the portions of the tufts of each of the bundles together. If desired, a secondary backing 20 may optionally be included adjacent the back side 18 to enhance dimensional stability characteristics of the turf 10. The turf 10 described herein is configured for applications where the turf is desired to have good drainage properties.

The primary backing 12 is preferably a woven polyolefin scrim material, such as a polyolefin polypropylene scrim preferably having a pick count of from about 8 to about 18 picks per square inch and a weight of from about 3 to about 6 oz/yd². The secondary backing 20 is preferably about a 3 to about 6 oz/yd² needle punch nonwoven polypropylene backing.

The adhesive 16 is preferably a hot melt or thermoplastic adhesive with a ring and ball softening point of about 225° F. and a corresponding viscosity of about 10,000 cp at 325° F., and may optionally include various fillers such as calcium carbonate, clay, and the like. The adhesive 16 is preferably applied onto the back side 18 in an amount of from about 6 to about 12 oz/yd². It has been observed that this relatively small amount of adhesive applied in the manner described sufficiently locks the fibers 14 in place. As will be appreciated, use of a relatively small amount of adhesive reduces costs and achieves weight savings and a desirably supple hand.

Another advantage of using this small amount of adhesive is that it leaves sufficient adhesive free areas so as to enable desired permeability characteristics of the turf to be achieved, as described in more detail below. As used herein, “sufficient locking” means a tuft lock strength of at least 5 pounds in accordance with the tuft lock test of ASTM-D 1335. The tuft lock strength is the force required to remove a single tuft from its primary backing. A tuft is one cut or uncut loop of the fibers.

With regard to the above mentioned desired permeability characteristics, it has been observed that the synthetic turf products described herein have adequate drainage properties such that subsequent punching or drilling of apertures therethrough is not needed. The terminology “adequate drainage” means that the turf, that is the structure corresponding to the primary backing 12 with the fibers 14 and the adhesive 16 applied thereto to achieve the desired lock strength, has a water permeability of greater than 40 inches/hour in accordance with test DIN 18-035.

The application of one or more secondary backings may decrease the water permeability. Accordingly, it will be appreciated that for applications requiring good drainage properties, the type and number of secondary backings should be selected to avoid unduly decreasing the drainage properties of the structure of the primary backing 12/fibers/14/adhesive 16.

Turning now to FIG. 2, there is shown a preferred process for manufacture of the turf 10. A tufted scrim material 30, preferably provided in roll form, is tensioned as by tensioning rollers 32 and a hot melt adhesive 34 is applied to a back side 36 of the material 30 as by a sprayer 38. The sprayer 38 may be static and dimensioned to the scrim or may be of a dimension smaller than the width to which adhesive is applied and moved laterally back and forth across the width of the scrim material. The adhesive 34 is preferably applied at a rate of from about 6 to about 12 oz/yd². The low amount of adhesive advantageously reduces costs associated with the manufacture of the turf and also reduces the weight of the product, which yields lower shipping costs. The low amount of adhesive can also result in desirable drainage properties, as described in more detail below.

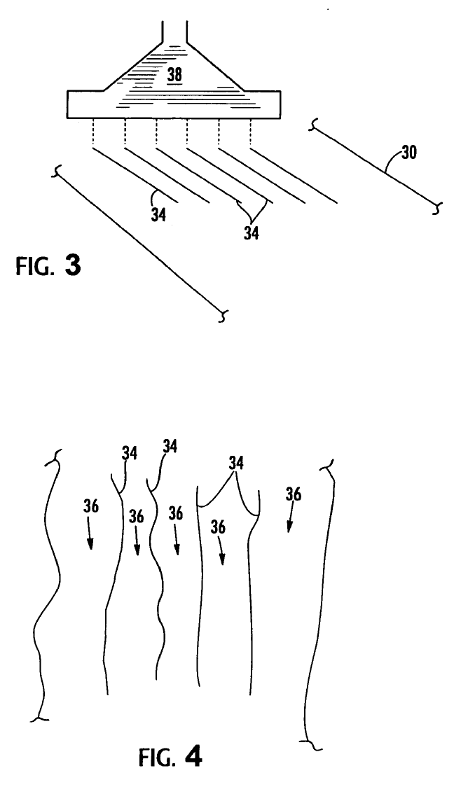

With reference to FIG. 3, there is shown the sprayer 38 applying the adhesive 34 to the back side 36 of the material 30. As shown, it is preferred to apply the adhesive 34 in a plurality of discrete segments or lines so as to avoid application of a continuous layer of the adhesive. In the event the sprayer 38 is moved across the width of the scrim during application, the segments will often overlap or crisscross, but still defining a plurality of adhesive free areas.

The thus treated material 30 is then contacted with one or more heated drums or rollers 40, and preferably positioned to run directly against and around the rollers 40, such that the back side 36 and the adhesive 34 applied thereto is adjacent to the drum 40. The drum 40 preferably has a diameter of from about 2 to about 6 feet, and is maintained at a temperature substantially corresponding to, and preferably slightly below the ring and ball softening point of the adhesive so that the adhesive is reactivated to be substantially plastic or somewhat soft and liquid-like. In this manner, the relatively soft or plastic state of the adhesive and the mechanical forces imparted by the drum promote penetration of the adhesive into the interstices of the tuft bundles. For the described adhesives, the preferred drum temperature is preferably from about 220 to about 230° F. for an adhesive having a ring and ball softening point of about 225° F.

It has been observed that the adhesive cools quickly below its ring and ball softening point upon application by the sprayer. That is, as the adhesive contacts the ambient air and the ambient surface of the back side 36 of the material 30, it quickly cools to a temperature below its ring and ball softening point. Thus, use of one or more of the heated drums or rollers 40 advantageously serves to re-heat or reactivate the adhesive to its ring and ball softening point and lower its viscosity for better wetting of the tuft bundles on the back of the material.

Also, the mechanical action imparted by the drum together with the decreased viscosity of the adhesive due to the favorable temperature conditions has been observed to promote a working of the adhesive into the interstices between adjacent tufts of the bundles of tufts to achieve enhanced bundle penetration. In this regard, the term “bundle penetration” will be understood to refer to the degree of penetration of the adhesive into the bundle of tufts so as to lock the individual tufts of the bundle together. It has been observed that a high degree of bundle penetration, generally approaching 100 percent, may be achieved by the method of the invention and that such bundle penetration is advantageous and complimentary of achieving the desired level of tuft lock.

With reference to FIG. 4, it has been observed that use of a sufficiently small volume of the adhesive results in a fragmented or non-continuous presence of the adhesive 34 on the back side 36 of the material 30 so as to provide a plurality adhesive free areas 36. The adhesive free areas 36 preferably correspond to a sufficient area that is substantially void of adhesive so as to provide the desired permeability characteristics. That is, the areas occupied by the adhesive are substantially impermeable, but the adhesive free areas are substantially permeable. Thus, the relatively low amount of adhesive utilized yields a sufficient area of the backing that is free of adhesive such that the resulting permeability of the resulting turf structure has a water permeability of greater than 40 inches/hour in accordance with test DIN 18-035.

If desired, one or more secondary backings, such as secondary backing 42, may be applied as by running the backing 42 adjacent the material exiting the drum 40 and passing the composite through a nip 44, with the adhesive 34 providing sufficient bonding.

It has been observed that the foregoing described step involving the drum 40 renders the adhesive 34 in a fluid state and under conditions sufficient to force the adhesive into the interstices of the fibers and the primary backing material of the material 30 such that the fibers become sufficiently locked to the primary backing material, yet with a sufficient area of the backing being substantially adhesive free so as to provide the desired permeability characteristics. It has been observed that the secondary backing promotes a construction which yields desirable tuft lock properties.

In addition, it has been observed that the process does not disrupt the permeability of the composite such that the resulting material has the afore described drainage properties. In this regard, it has been observed that the use of a relatively small amount of adhesive applied as described advantageously provides sufficient adhesive strength yet is present in such a small amount so as to be unable to be present as a continuous layer or film. This results in a sufficient amount of adhesive free locations on the back side 18 that yields the desired permeability characteristics.

The foregoing process steps thus enable manufacture of the turf 10 having improved characteristics as compared to conventional synthetic turf. For example, as will be observed, the foregoing process avoids the need for a curing oven, thus avoiding shrinkage, the formation of wrinkles, and application of excessive heat to the face fibers. In addition, the adhesive is applied in an amount and a manner which provides sufficient locking of the fibers, but without disadvantageously affecting drainage characteristics. Thus, no further punching or forming of the turf is needed to provide adequate drainage.

It will be understood, however, that the adhesive may be applied as a substantially continuous film or coating, or in greater amounts, or both, if it is desired that the turf be substantially impermeable.

The foregoing description of certain exemplary embodiments of the present invention has been provided for purposes of illustration only, and it is understood that numerous modifications or alterations may be made in and to the illustrated embodiments without departing from the spirit and scope of the invention as defined in the following claims.

What is claimed is:

1. A synthetic turf, comprising a tufted material having a hot melt adhesive applied to a back side thereof at a rate of no more than about 12 oz/yd², wherein the turf has a tuft lock strength of at least 5 pounds in accordance with the tuft lock test of ASTM-D 1335 and a water permeability of at least about 40 inches/hour in accordance with test DIN 18-035.

2. The turf of claim 1, wherein the adhesive is applied at a rate of from about 6 to about 12 oz/yd².

3. The turf of claim 1, wherein the adhesive is present as a substantially discontinuous layer so as to define a plurality of adhesive free areas.

4. The turf of claim 1, further comprising a secondary backing comprising a woven or nonwoven scrim.

5. The turf of claim 1, wherein the synthetic turf composite is made of thermoplastic polymers.

6. The turf of claim 5, wherein the thermoplastic polymers are recyclable into a hot melt adhesive and/or moldable plastic.

7. The turf of claim 1, wherein the adhesive has a ring and ball softening point of about 225° F. and a corresponding viscosity of about 10,000 cp at 325° F.

8. A synthetic turf, comprising a tufted material having a hot melt adhesive applied to a back side of a primary backing at a rate of no more than about 12 oz/yd², wherein the turf has a tuft lock strength of at least 5 pounds in accordance with the tuft lock test of ASTM-D 1335 and a water permeability of at least about 40 inches/hour in accordance with test DIN 18-035.

9. The turf of claim 8, wherein the primary backing is a woven polyolefin scrim material.

10. The turf of claim 9, wherein the woven polyolefin scrim material is a polyolefin polypropylene scrim having a pick count of from about 8 to about 18 picks per square inch and a weight of from about 3 to about 6 oz/yd².

11. The turf of claim 8, wherein the adhesive is applied at a rate of from about 6 to about 12 oz/yd².

12. The turf of claim 8, wherein the adhesive is present as a substantially discontinuous layer so as to define a plurality of adhesive free areas.

13. The turf of claim 8, further comprising a secondary backing comprising a woven or nonwoven scrim.

14. The turf of claim 8, wherein the synthetic turf composite is made of thermoplastic polymers.

15. The turf of claim 14, wherein the thermoplastic polymers are recyclable into a hot melt adhesive and/or moldable plastic.

16. The turf of claim 8, wherein the adhesive has a ring and ball softening point of about 225° F. and a corresponding viscosity of about 10,000 cp at 325° F.
